(19) United States
(12) Patent Application Publication
(10) Pub. No.: US 2008/0145567 A1
(43) Pub. Date: Jun. 19, 2008

(54) Laser Machining Method for Printed Circuit Board

(75) Inventors: Goichi OHMAE, Ebina-shi (JP); Hiroshi Aoyama, Ebina-shi (JP); Yasuhiko Kanaya, Ebina-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebini-shi (JP)

(21) Appl. No.: 11/950,859

(22) Filed: Dec. 5, 2007

(30) Foreign Application Priority Data
Dec. 6, 2006 (JP) 2006-329559

(51) Int. Cl. B05D 3/06

(52) U.S. Cl. 427/554

(57) ABSTRACT

A printed circuit board manufacturing method by which the manufacturing time can be shortened and the manufacturing cost can be reduced. A printed circuit board has an insulating layer on its surface. Positions (first positions) of the printed circuit board where lands are disposed are irradiated with a CO₂ laser beam (first laser beam) so as to form holes with a depth h from the surface. The printed circuit board is then scanned with an excimer laser beam (second laser beam) through a mask. The beam shape of the excimer laser beam is rectangular. Thus, holes reaching the lands are formed in the positions where the lands are disposed, and grooves for forming lines are formed (second positions). In this case, the holes reaching the lands may be formed by the CO₂ laser beam.

### FIELD OF THE INVENTION

The present invention relates to a method for manufacturing a printed circuit board.

### BACKGROUND OF THE INVENTION

As a method for manufacturing a printed circuit board provided with fine wiring, Patent Document 1 discloses a method in which grooves corresponding to a wiring pattern are formed in a surface insulating layer of a printed circuit board, a conductor layer (a precursor of the wiring pattern) is deposited in the formed grooves, and the excessive deposit of the conductor layer is then removed from the surface of the printed circuit board. In this method, through holes for connecting a wiring pattern of an internal layer with the wiring pattern formed in the surface layer are machined by a laser before the grooves corresponding to the wiring pattern are formed. According to this method, a printed circuit board having a flat surface can be formed.

It is also attempted to produce a wiring pattern by use of an excimer laser whose sectional beam shape (hereinafter referred to as “beam shape”) is formed into a rectangular shape (Non-Patent Document 1).

There is also known a technique in which a metallic conductor layer of a surface is used as a mask to form a blind hole by an excimer laser whose beam shape is formed into a rectangular shape (Patent Document 2).

Patent Document 1: JP-A-2006-41029

Patent Document 2: JP-A-7-336055

Non-Patent Document 1: Phil Rumsby et al. Proc. SPIE Vol. 3184, p. 176-185, 1997

In the invention disclosed in Patent Document 1, however, the grooves corresponding to the wiring pattern are formed by soft etching, such as an anisotropic plasma etching. Therefore, the process for forming the grooves has to include at least:
a. photo-resist application step
b. photo-resist curing step
c. exposure step
d. development step
e. soft etching step

The technique disclosed in Non-Patent Document 1 has no suggestion about means for connecting the wiring pattern of the internal layer with the wiring pattern formed in the surface.

### SUMMARY OF THE INVENTION

An object of the present invention is to solve the foregoing problems. Another object of the present invention is to provide a printed circuit board manufacturing method by which the manufacturing time can be shortened and the manufacturing cost can be reduced.

In order to attain the foregoing objects, a first configuration of the present invention provides a printed circuit board manufacturing method characterized as follows. That is, predetermined first positions of a printed circuit board which has an insulating layer on the surface thereof are irradiated with a first laser beam. Thus, holes are formed with a predetermined depth from the surface. Then, the first positions and predetermined second positions of the printed circuit board are irradiated with a second laser beam. Thus, holes deep enough to reach a conductor layer of an internal layer are formed in the first positions, and grooves shallow enough not to reach the conductor layer of the internal layer are formed in the second positions. Then, a conductive material is applied to fill the holes and the grooves so as to form a conductor pattern.

In this case, the holes formed by the first laser beam may be made deep enough to reach the conductor layer of the internal layer. Alternatively, each hole formed by the first laser beam may be made shallow enough not to reach the conductor layer of the internal layer while the height from the conductor layer to the hole bottom of each formed hole is made not greater than the depth of each groove formed by the second laser beam.

A second configuration of the present invention provides a printed circuit board manufacturing method characterized as follows. That is, predetermined first and second positions of a printed circuit board which has an insulating layer on the surface thereof are irradiated with a second laser beam. Thus, holes and grooves which are shallow enough not to reach a conductor layer of an internal layer are formed. Then, the first positions are irradiated with a first laser beam or the second laser beam. Thus, holes which are deep enough to reach the conductor layer of the internal layer are formed. Then, a conductive material is applied to fill the holes and the grooves so as to form a conductor pattern.

The number of machining steps for forming the grooves and the holes can be reduced so that the manufacturing time of the printed circuit board can be shortened and the manufacturing cost thereof can be reduced.

### BRIEF DESCRIPTION OF THE DRAWINGS

FIGS. 1a1-1a3 and 1b1-1b3 are views showing a manufacturing procedure according to the present invention;

FIG. 2 is a main portion configuration view of an excimer laser beam machine suitable for using the present invention; and

FIG. 3 is a view showing a preferred machining example for using the present invention.

### DETAILED DESCRIPTION OF EMBODIMENT

An embodiment of the present invention will be described below with reference to the drawings.

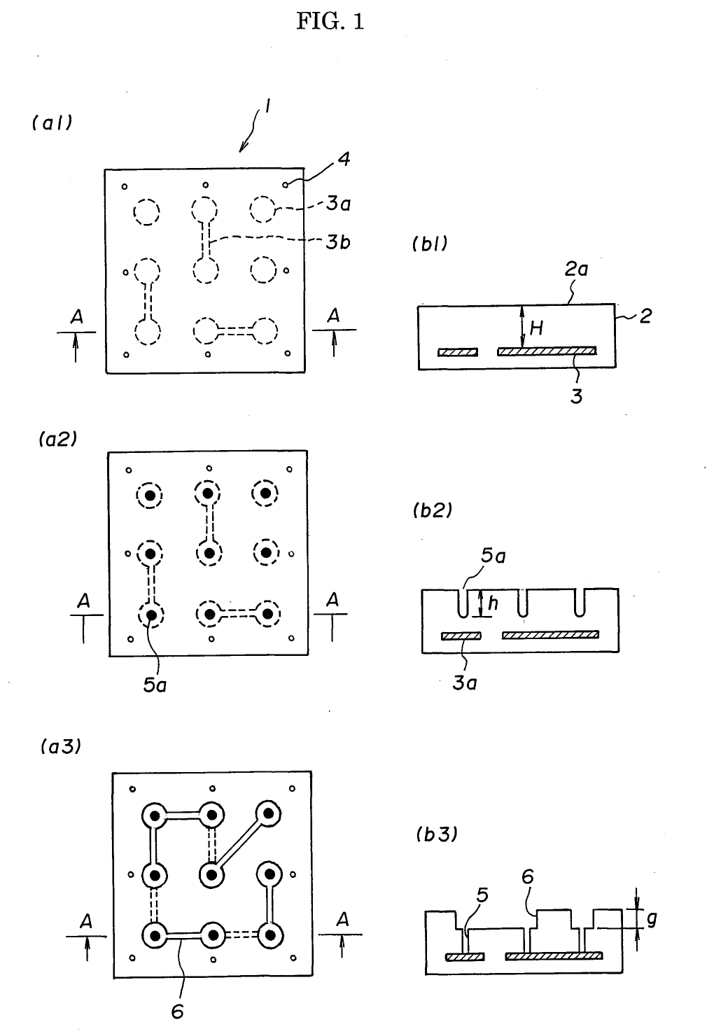

FIGS. 1a1-1a3 and 1b1-1b3 are views showing a machining procedure according to the present invention. FIGS. 1a1-1a3 are plan views (surface views), and FIGS. 1b1-1b3 are sections along the line A-A in FIGS. 1a1-1a3.

A printed circuit board 1 is constituted by an insulator 2 and a conductor layer 3. The insulator 2 is made of a material (for example, thermosetting resin such as epoxy resin, polyimide resin, phenol resin, etc.) suitable for forming a fine pattern with a line width of about 10 μm. As shown in FIG. 1b1, the conductor layer (internal layer) 3 made of copper is disposed in a position of height H from a surface 2a. As shown in FIG. 1a1, the conductor layer 3 is containing circular lands 3a and lines 3b. Each line 3b connects one land 3a with another land 3a. Alignment marks 4 (nine in each of FIGS. 1a1-1a3) serving as position references for irradiation with a laser beam are formed at predetermined positions when the conductor layer 3 is formed (that is, the alignment marks 4 are made of the same material as the conductor layer 3).

First, as shown in FIG. 1b2, holes 5a of depth h (h<H) from the surface 2a are formed by a CO₂ laser beam whose section is circular. That is, with reference to each alignment mark 4, the optical axis of the CO₂ laser beam is positioned at the center of a land 3a to be machined, and the pulsed CO₂ laser beam is then emitted. In this case, it is preferable to select machining conditions where each hole 5 can be formed so that the diameter at its bottom is close to the diameter at its mouth. The depth h will be described in detail later.

Next, a mask which will be described later is scanned with an excimer laser beam whose beam shape is made rectangular. A laser transmission portion corresponding to the conductor pattern has been formed in the mask. As shown in FIGS. 1a3 and 1b3, the excimer laser beam transmitted by the mask forms each groove 6 of depth g in the surface of the insulator 2, and removes the remaining portion of the insulator 2 lying between the bottom of each hole 5a and its corresponding land 3a.

That is, the depth h is defined as:

h≧(H−g)

or preferably as:

h≧1.2(H−g)

In this case, the depth h may be set as h=H.

When the grooves 6 and the holes 5 for forming the conductor pattern have been machined out, the conductor pattern is completed by use of a known technique (for example, nonelectrolytic copper plating is performed all over the surface, copper is then applied to fill the grooves 6 and the holes 5 in an electrolytic copper plating process, and the surface is polished sufficiently). After that, the surface is further coated or laminated with resin. The procedure which has been described above is repeated to manufacture a multi-layer board.

A specific example will be described below.

First, description will be made about machining of the holes 5. A laser beam machine for forming the holes is known well, and description thereof will be omitted. Here, the material of the insulator 2 is an epoxy resin, and the depth H from the surface 2a to the conductor layer 3 is 35 μm.

When each hole 5 is formed with a diameter of 60 μm by a CO₂ laser beam machine, with pulses having a wavelength of 9.4 μm, an energy density of 10-15 J/cm² and a pulse width of 15 μm. In these conditions, two pulses are sufficient to make each hole 5 with a depth h of 30-35 μm. In this case, the diameter at the bottom of the hole 5 was 50 μm.

To form the holes 5, the CO₂ laser beam may be replaced by an excimer laser beam or a solid state UV laser beam. In order to form each hole 5 with a diameter of 60 μm by use of the excimer laser beam, the printed circuit board 1 must be irradiated with about 55 pulses when the energy in the portion to be machined is 1 J/cm². In the case of the UV laser, the printed circuit board 1 must be irradiated with about 60-70 pulses when the energy in the portion to be machined is 0.8 J/cm².

Next, description will be made about machining of the grooves 6.

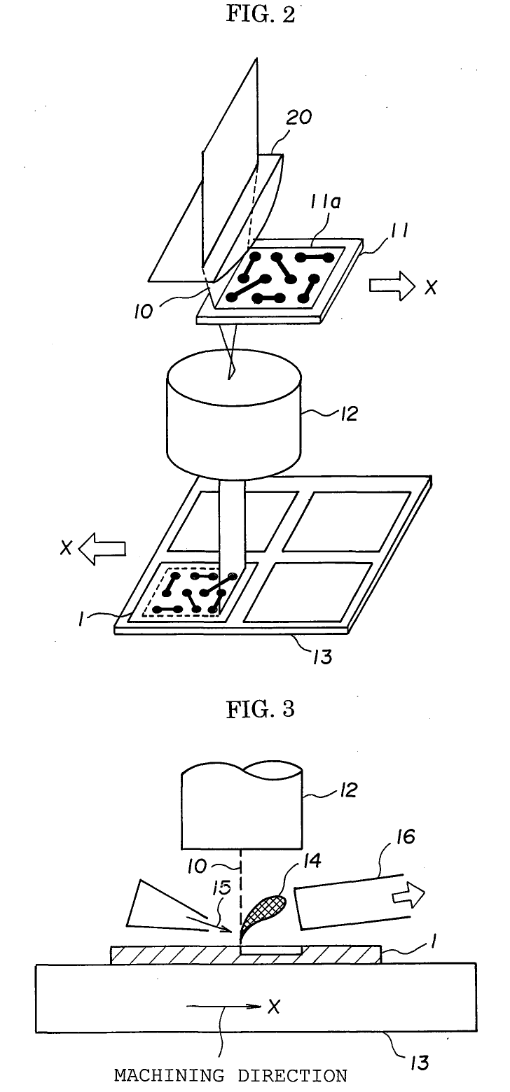

FIG. 2 is a main portion configuration view of an excimer laser beam machine for completing the grooves 6 and the holes 5.

A laser beam is generated from an excimer laser by laser oscillation, and shaped into a rectangular beam (hereinafter referred to as “line beam 10”) by a homogenizer (beam intensity distribution shaper), that is, a section perpendicular to the central axis (optical axis) is approximately a rectangle. The line beam 10 has a uniform beam intensity distribution. The line beam 10 is 130 mm long and 6 mm wide. The line beam 10 is emitted in the form of pulses. The line beam 10 is condensed by a cylindrical lens 20 and incident on a mask 11.

The material of the mask 11 is quartz glass, and one surface of the mask 11 is coated with chromium coating 11a. Chromium layer is removed from portions of the chromium coating 11a which must transmit the line beam 10 (that is, portions of a similar pattern to (and here five times as large as) a conductor pattern to be machined). In this embodiment, the region of the mask 11 from which corresponding chromium portions are removed off (hereinafter referred to as “pattern size”) is an area of 125 mm by 125 mm. By a not-shown moving means, the mask 11 can be moved in the X direction perpendicular to the longer side of the line beam 10 whose irradiation position is fixed.

A projection lens 12 is positioned so that its central axis coincides with the central axis of the line beam 10.

The printed circuit board 1 is fixed onto a table 13. By a not shown moving means, the table 13 can be moved in a direction parallel to the moving direction of the mask 11.

To machine the printed circuit board 1, the mask 11 and the printed circuit board 1 are moved (scanned) oppositely to each other with respect to the fixed laser beam 10 and the fixed projection lens 12. Thus, the conductor pattern formed in the mask 11 is reduced and transferred to the surface of the printed circuit board 1 (hereinafter referred to as “scan processing”). In this embodiment, the pattern size on the printed circuit board 1 is 25 mm by 25 mm because the reduction ratio is 1/5. Therefore, the moving velocity of the printed circuit board 1 is adjusted to Vs/5, where Vs designates the moving velocity of the mask 11.

Here, description will be made about the moving velocity Vs of the mask 11 in the scan processing.

When D designates the machining depth per pulse (etching rate), the number N of shots required for obtaining machining depth g can be obtained by:

N=g/D

When M designates the reduction ratio of the projection lens 12, f designates the repetition frequency of pulses, and w designates the beam width of the laser beam 10, the moving velocity Vs of the mask 11 can be obtained by:

Vs=fw/MN

The printed circuit board 1 was irradiated with 15 pulses of an excimer laser beam with a wavelength of 308 nm, a pulse width of 40 ns, an energy density of 1 J/cm² in a portion to be machined, and a pulse repetition frequency of 50 Hz. Thus, each groove 6 could be machined out on the printed circuit board 1 with a groove width of 10 μm, a distance of 10 μm between the groove 6 and adjacent one, and a depth g of 10 μm.

In the scan processing, there may appear scattered particles (evaporated vapor of the insulator 2, especially), which will be referred to as “debris 14”. The distance between the lower surface of the projection lens 12 and the printed circuit board 1 is generally so short that the debris 14 may often adhere to the projection lens 12. In addition, the index of refraction of the atmosphere passed by the line beam 10 changes due to the debris 14 so that the image of the conductor pattern may be out of focus. Therefore, as shown in FIG. 3, a gas 15 for removing the debris 14 is emitted out toward the portion to be machined (the position where the line beam 10 is incident on the printed circuit board 1) from an oblong outlet which is disposed on the unmachined side with respect to the relative moving direction of the line beam 10. Moreover, the debris 14 is exhausted through also an oblong inlet by a vacuum means 16 disposed on the side where machining has been finished. In such a manner, the machining accuracy can be improved while the debris 14 can be prevented from adhering to the projection lens 12. It is desired that an inert gas such as helium, nitrogen gas or the like not to enhance the debris 14 to burn is used as the gas 15 for removing the debris 14 from the portion to be machined.

When the holes 5 are machined by a CO₂ laser beam, the machining efficiency can be improved. However, carbonaceous residue called smear with minute thickness (0.2-0.3 μm) may remain in the hole bottoms. In the background art, a so-called desmearing step for chemically dissolving and removing the smear is required. In this embodiment, the holes 5 machined out by the CO₂ laser beam are further irradiated with an excimer laser beam which will not produce any smear. Thus, there is no fear that smear remains in the hole bottoms. It is therefore possible to perform machining with improved machining efficiency and with high reliability.

An apparatus which can output both the CO₂ laser beam and the excimer laser beam may be used as a laser machining apparatus. Alternatively, a laser machining apparatus which can output the CO₂ laser beam and another laser machining apparatus which can output the excimer laser beam may be used.

The irradiation order of the CO₂ laser beam (or solid state UV laser beam) and the excimer laser beam may be reversed. That is, the holes 5 may be formed after the grooves 6 are formed.

### DESCRIPTION OF REFERENCE NUMERALS

1 PRINTED CIRCUIT BOARD

2 INSULATING LAYER

3a LAND

5,5a HOLE

6 GROOVE

11 MASK

1. A printed circuit board manufacturing method comprising the steps of:
irradiating predetermined first positions of a printed circuit board, which has an insulating layer on a surface thereof, with a first laser beam so as to form holes with a predetermined depth from the surface;
thereafter irradiating the first positions and predetermined second positions of the printed circuit board with a second laser beam so as to form holes in the first positions and grooves in the second positions respectively, the holes being deep enough to reach a conductor layer of an internal layer, the grooves being shallow enough not to reach the conductor layer of the internal layer; and
thereafter applying a conductive material to fill the holes and the grooves so as to form a conductor pattern.

2. A printed circuit board manufacturing method according to claim 1, wherein the holes formed by the first laser beam are deep enough to reach the conductor layer of the internal layer.

3. A printed circuit board manufacturing method according to claim 1, wherein each hole formed by the first laser beam is shallow enough not to reach the conductor layer of the internal layer, and the height from the conductor layer to the hole bottom of each formed hole is not greater than the depth of each groove formed by the second laser beam.

4. A printed circuit board manufacturing method comprising the steps of:
irradiating predetermined first and second positions of a printed circuit board, which has an insulating layer on a surface thereof, with a second laser beam so as to form holes and grooves which are shallow enough not to reach a conductor layer of an internal layer;
thereafter irradiating the first positions with a first laser beam or the second laser beam so as to form holes which are deep enough to reach the conductor layer of the internal layer; and
thereafter applying a conductive material to fill the holes and the grooves so as to form a conductor pattern.

5. A printed circuit board manufacturing method according to claim 1, wherein a section of the second laser beam is shaped into an approximate rectangle whose longer side is much greater than shorter side in length.

6. A printed circuit board manufacturing method according to claim 5, wherein when the second laser beam and the printed circuit board are moved relatively to each other, a gas for removing vapor generated by machining is emitted out from an outlet disposed on the unmachined side with respect to a moving direction of the second laser beam in a position where the second laser beam is incident on the printed circuit board.

7. A printed circuit board manufacturing method according to claim 4, wherein a section of the second laser beam is shaped into an approximate rectangle whose longer side is much greater than shorter side in length.
